(19) United States
(12) Patent Application Publication
(10) Pub. No.: US 2018/0119784 A1
(43) Pub. Date: May 3, 2018

(54) POWERTRAIN OF TWO SPEED TRANSMISSION FOR ELECTRIC-ONLY VEHICLE

(71) Applicant: NIO NEXTEV LIMITED, Hong Kong (CN)

(72) Inventor: Ting CUI, Shanghai (CN)

(21) Appl. No.: 15/795,809

(22) Filed: Oct. 27, 2017

(30) Foreign Application Priority Data
Oct. 27, 2016 (CN) 201610973452.7

(51) Int. Cl. F16H 37/04

(52) U.S. Cl. CPC F16H 37/04; F16H 2200/0034

(57) ABSTRACT

The present application relates to the field of vehicle transmission system, particularly to a powertrain of two speed transmission for electric-only vehicle. The present application aims at solving the problem existed in the prior art dual-clutch transmission, that is, occupying too much space and being unsuitable for other types of electric vehicles. The powertrain comprises a housing as well as an input shaft and an output shaft rotatably secured to the housing. Several components are provided within the housing: a planetary mechanism, an input gear into which the input shaft is inserted and with which the planet carrier is fixedly connected, and an output gear in fixed connection with the output shaft. A clutch is provided between the input shaft and the input gear, and a brake is provided between the outer ring gear of the planetary mechanism and the housing. When the input shaft is driven to rotate by the driving motor, gear shifting is achieved by controlling the connection and disconnection of the clutch and the brake by the oil pump. Hence, the powertrain of the two speed transmission of the application is more compact, convenient for arrangement, thereby improving the vehicle power performance.

### CROSS-REFERENCE TO RELATED APPLICATIONS

This application claims the benefit of China Patent Application No. CN201610973452.7 filed Oct. 27, 2016, the entire contents of which are incorporated herein by reference.

### TECHNICAL FIELD

The present application relates to the field of vehicle transmission system, particularly to a powertrain of two speed transmission for electric-only vehicle.

### BACKGROUND

Since the driving motors have such characteristics as constant torque at low speed, constant power at high speed as well as wider operation range, when developing electric-only vehicles on the basis of traditional vehicles, many domestic vehicle manufacturers employ drivelines of constant speed ratios, which basically meet the requirement of driving. Yet in practice, an electric vehicle with constant speed ratios typically has such problems as motor overheating during low speed climbing, field weakening and more noise at high speed due to complex road conditions. Additionally, it is impossible for motors to always work at premium efficiency, resulting in disadvantages of faster power consumption and shorter driving range. Furthermore, it is often necessary for motors to possess better performances to meet designed performance of electric-only vehicles.

A powertrain of two speed transmission for electric-only vehicle as an optimized solution is widely used, because it effectively solves such problems of electric vehicle with constant speed ratios as motor overheating during low speed climbing, field weakening and more noise at high speed. Usually, current powertrains of two speed transmission are mainly automatic transmissions, especially dual clutch transmission system, which are very popular with users due to simple structure, low costs, excellent gear shifting performance etc. However, existing dual clutch transmissions occupy too much space and are unsuitable for other types of electric vehicles.

Accordingly, there is a need in the art for a new two speed transmission for electric vehicle to solve the previously mentioned problems.

### SUMMARY

To solve the above described problems in the prior art, i.e., existing dual clutch transmissions occupy too much space and are unsuitable for other types of electric vehicles, the present application provides a powertrain of two speed transmission in an electric-only vehicle, the powertrain comprises a housing as well as an input shaft and an output shaft rotatably secured to the housing, wherein the following components are provided within the housing: a planetary mechanism which includes a sun gear, an outer ring gear rotatably secured to the housing and planet gears provided between the sun gear and the outer ring gear in radial direction and intermeshing respectively with the sun gear and the outer ring gear, the sun gear and the input shaft are in fixed connection with one another; a reducer which includes an input gear into which the input shaft is inserted and an output gear coaxially fixed with the output shaft, the input gear is connected with the planet gears, the input gear is intermeshing with the output gear in assembled state; a clutch which has a clutch driving disk coaxially secured to the input shaft and a clutch driven disk coaxially secured to the input gear; and a brake which has a brake driving disk in fixed connection with the housing and a brake driven disk in fixed connection with the outer ring gear.

In a preferred embodiment of the above powertrain, the planetary mechanism further includes a planet carrier, one end of which is connected with the planet gears, another end of which is in fixed connection with the input gear.

In a preferred embodiment of the above powertrain, bearings are respectively provided between the housing and the input shaft, between the housing and the output shaft and between the housing and the supporting shaft in radial direction.

In a preferred embodiment of the above powertrain, the power unit includes an oil pump, which is connected respectively with the clutch and the brake through lines; the oil pump is used for putting the clutch driving disk and the clutch driven disk into engaged or disengaged state and putting the brake driving disk and the brake driven disk into engaged or disengaged state.

In a preferred embodiment of the above powertrain, the oil pump is connected respectively with the clutch driving disk and the brake driving disk through the lines.

In a preferred embodiment of the above powertrain, the powertrain of two speed transmission further includes a control unit for controlling the oil pump to make the clutch driving and driven disks as well as the brake driving and driven disks disengage from or engage with each other.

In a preferred embodiment of the above powertrain, there is provided a supporting shaft in central axis direction of the outer ring gear, the body of the supporting shaft is connected to the housing in a rotatable way.

In a preferred embodiment of the above powertrain, the planetary mechanism has a single row of planetary gears.

In a preferred embodiment of the above powertrain, the clutch is a wet multi-disk clutch.

In a preferred embodiment of the above powertrain, the powertrain comprises a driving motor, the rotation shaft of which is in fixed connection with the input shaft.

As can be understood by those skilled in the art, in the preferred embodiments of the application, gear shifting of the two speed transmission is achieved by fixedly connecting the rotation shafts of the planet gears with the input gear through the planet carrier, by controlling the connection and disconnection of the input gear and the input shaft through the clutch, by controlling the rotation and locking of the outer ring gear via the brake, by controlling the connection and disconnection of the clutch and the brake with the oil pump. Transmission ratios of electric vehicle can be controlled (this is, gear shifting) without power interruption by controlling the oil pump through the control unit and thus controlling the connection and disconnection rate of the clutch and brake, thus improving vehicle power performance and comfort. In addition, the two speed transmission is in neutral position when the clutch and brake are all in disengaged state. Further, by packing the reducer and the planetary mechanism within the housing by means of the planet carrier, the structure of the two speed transmission of the application is quite simple, more compact and convenient for arrangement.

### BRIEF DESCRIPTION OF THE DRAWINGS

FIG. 1 is a structural schematic view of a powertrain of two speed transmission of the application;

FIG. 2 is a structural schematic view of the powertrain of two speed transmission of the application in its first gear state; and

FIG. 3 is a structural schematic view of the powertrain of two speed transmission of the application in its second gear state.

### LIST OF REFERENCE SIGNS

1 housing; 2 input shaft; 3 output shaft; 4 reducer; 41 input gear; 42 output gear; 5 planetary mechanism; 51 sun gear; 52 outer ring gear; 53 planet gear; 54 planet carrier; 55 supporting shaft; 6 brake; 61 brake driving disk; 62 brake driven disk; 7 clutch; 71 clutch driving disk; 72 clutch driven disk; 8 oil pump; 9 driving motor.

### DETAILED DESCRIPTION

The preferred embodiments of the application are described below with reference to the accompanying figures. As will be understood by those skilled in the art, these embodiments are simply used for interpreting the technical principle of the application and are not intended to limit its protection scope in any way. For example, although only an oil pump of the power unit is shown to drive the clutch and brake, the powertrain obviously also includes other components such as a motor, a control valve assembly and a fuel tank etc. These embodiments can be modified as desired by skilled artisans to accommodate specific applications.

It should be pointed out that in the description of the application, such directional and positional terms as central, upper, lower, left, right, vertical, horizontal, inner and outer, given on the basis of the directional and positional relations shown in the drawings, are used to facilitate the description itself and does not express or imply the necessary specific positions or specific operational and structural positions of the devices or elements of the disclosure. Therefore, the usage is not to be construed as limitation on the application. Additionally, terms first, second and third are merely provided for the purposes of description other than expressing or implying their relative importance.

Moreover, it should also be noted that in the description of the application, unless otherwise unambiguously specified and defined, the terms of install, connect and couple, should be construed in their broad senses; for example, they can be permanent or detachable or integrally connecting, mechanically or electrically connecting, directly connecting or indirectly connecting via a third part, or even connecting between the inner parts of two elements. It will be understood by those skilled in the art that the specific meanings of the above terms vary in different context.

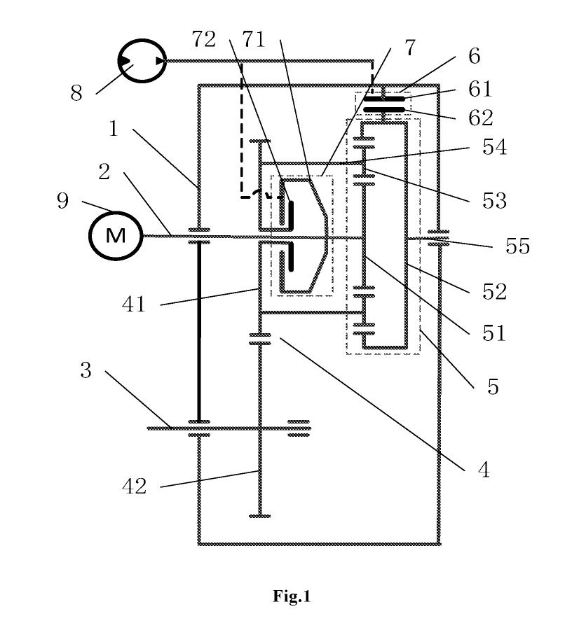

As shown in FIG. 1, the powertrain of two speed transmission for electric-only vehicle according to the present application comprises a housing 1, an input shaft 2, an output shaft 3, a reducer 4, a planetary mechanism 5, a brake 6, a clutch 7, a power unit (not completely shown in the figures) and a driving motor 9. The power unit includes an oil pump 8. The input shaft 2 and the output shaft 3 are rotatably secured to the housing 1. Specifically, there are also bearings (not shown in the figures) respectively provided between the shafts and the housing 1 in a radial direction of the shafts. The left end of the input shaft 2 (the left end of the input shaft 2 shown in FIG. 1) and the rotation shaft of the driving motor 9 are in fixed connection with one another by a coupling, such that torque can be delivered from the driving motor 9 into the housing 1. The left end of the output shaft 3 are used for connecting respective power transmission mechanism and transferring torque out of the housing 1 to the power transmission mechanism, through which the torque is used to drive the wheels of an electric vehicle. In a preferred embodiment of the application, the planetary mechanism 5 has a single row of planetary gears, the clutch 7 is a wet multi-disk clutch, or other forms of planetary mechanism and other forms of clutch can also be selected as desired by those skilled in the art.

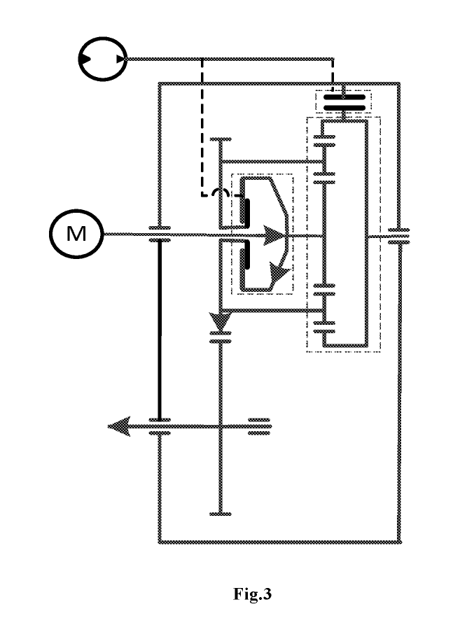

Referring still to FIG. 1, the reducer 4 has an input gear 41 and an output gear 42, which mesh with each other in assembled state. The input shaft 2 is inserted into the input gear 41, and a clearance is provided between them in the direction of radial mating surfaces. The output gear 42 and the output shaft 3 are coaxially fixed. The clutch 7 includes a clutch driving disk 71 coaxially secured to the input shaft 2 and a clutch driven disk 72 coaxially secured to the input gear 41, and in assembled state, the driving disk 71 and the driven disk 72 can engage with or disengage from one another. When the clutch driving disk 71 and the clutch driven disk 72 are engaged under external force, the input gear 41 can be driven to rotate (i.e., the state of second gear shown in FIG. 3).

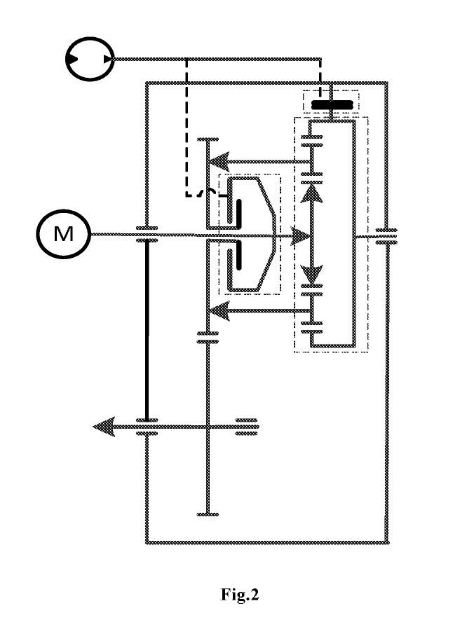

Referring further to FIG. 1, the planetary mechanism 5 mainly includes a sun gear 51, an outer ring gear 52, planet gears 53, a planet carrier 54 and a supporting shaft 55. The sun gear 51 is coaxially in fixed connection with the right end of input shaft 2 in FIG. 1. As shown in FIG. 1, the right end of the outer ring gear 52 and the left end of the supporting shaft 55 are coaxially fixed; the body of the supporting shaft 55 is rotatably mounted to the wall of the housing 1. Further, a bearing (not shown in the figures) can be provided between the supporting shaft 55 and the housing 1 in the radial direction of the shaft. The planet gears 53 are provided between the sun gear 51 and the outer ring gear 52 in radial direction and respectively intermesh with the sun gear 51 and the outer ring gear 52. As will be understood by those skilled in the art that the number of planet gear may vary as desired. As shown in FIG. 1, the left end of the planet carrier 54 and the input gear 41 are in fixed connection, and the right end of the planet carrier 54 and the planet gears 53 are connected together, and each planet gear 53 is capable of self-rotating around its connection point with the planet carrier 54. The brake 6 has a brake driving disk 61 fixed to the inner wall of the housing 1 and a brake driven disk 62 fixed to the outer ring gear 52. In assembled state, the driving disk 61 and the driven disk 62 can engage with or disengage from each other. When the brake driving disk 61 and the brake driven disk 62 are engaged with each other under external force, the outer ring gear 52 is braked and finally stopped from rotating, that is, the rotational degree of freedom is restricted (i.e., the first gear condition shown in FIG. 2). It should be readily understood by the skilled artisan that the brake 6 can be either provided between the outer ring gear 52 and the inner wall of the housing 1 in the radial direction of the outer ring gear 52 (as shown in FIG. 1) or provided between the outer ring gear 52 and the inner wall of the housing 1 (right side) in the axial direction of the outer ring gear 52, so long as the freedom degree of the outer ring gear 52 is restricted by engaging the brake driving and driven disks 61 and 62.

With continued reference to FIG. 1, the oil pump 8 is connected respectively with the brake 6 and the clutch 7 through lines and is used for switching the brake 6 and the clutch 7 into engaged/disengaged state by means of oil pressure. When the oil pump 8 leads high pressure oil to the brake 6 through lines, oil pressure drives the brake driving and driven disks 61 and 62 into engaged state. And when high pressure oil is unloaded from the lines and directed to a low pressure chamber (hydraulic fluid tank for example), the brake 6 and the brake driving disk 61 bring themselves to initial positions, and the driving disk 61 is disengaged from the driven disk 62. Likewise, the oil pump 8 puts the clutch driving disk 71 and the clutch driven disk 72 into engaged or disengaged state by raising or reducing oil pressure.

Preferably, each of the brake 6 and the clutch 7 is provided with a restoring spring so as to allow the brake driving disk 61 and the clutch driving disk 71 to automatically return to their original positions upon removing external force from them, or other restoring devices other than the restoring spring can be employed as desired by those skilled in the art.

As will be understood by the skilled person in this field, the oil pump 8 is usually driven to rotate by a motor connected with its rotation shaft to output high pressure oil. To further simplify the powertrain structure of the two speed transmission in the application, the motor and the oil pump can be integrated to deliver power respectively to the brake 6 and the clutch 7. As can be understood by those skilled in the art, to enable the oil pump 8 to respectively control the brake 6 and the clutch 7, there should be a respective valve assembly provided between the oil pump 8 and the lines or on the lines, which includes but not limited to selector valve, unloading valve and overflow valve.

Further, the powertrain of the two speed transmission for electric-only vehicle in the application also includes a control unit used for controlling components, including but not limited to the oil pump 8 and the valve assembly, through which the electric vehicle can realize sliding mode control of the brake 6 and the clutch 7 to switch gear ratios (shift gears) without power interruption, thereby improving the power performance and comfort of the whole vehicle.

With continued reference to FIG. 1, as can be seen in the figure, both the clutch 7 and the brake 6 are in disengaged state, and the planetary mechanism 5 has three degrees of freedom in this state (that is, the sun gear 51, the outer ring gear 52 and the planet gear 53 are all rotatable). Accordingly, when the input shaft 2 rotates, under the effect of output resistance (load), the sun gear 51 rotates along with the planet gear 53 in situ, the outer ring gear 52 is forced to rotate in a direction reverse to the rotating direction of the sun gear 51, such that the output shaft 3 outputs no power. The electric vehicle is now in neutral position. The power transmission processes of the two speed transmission in first gear state and in second gear state are briefly described in connection with FIG. 2 and FIG. 3 in the following.

With reference to FIG. 2, it shows the power transmission process of the two speed transmission in first gear state. At this point, under the high temperature oil output by the oil pump 8, the driving disk 61 and the driven disk 62 of the brake 6 are engaged and the driving disk 71 and the driven disk 72 of the clutch 7 are disengaged. Under such circumstance, the outer ring gear 52 is locked into the housing 1, one of the three degrees of freedom of the planetary mechanism 5 is restricted, and the planetary mechanism 5 becomes a one speed transmission device, transmission ratio of which is i=(Zr+Zs)/Zs, wherein Zr is the tooth number of the outer ring gear 52, and Zs is the tooth number of the sun gear 51. The process of torque transmission is that: torque output by the driving motor 9 is delivered to the output shaft 3 through the planetary mechanism 5, the transmission ratio i of the planetary mechanism 5 slows down the speed of the output shaft 3 and increases its torque. Specifically, the torque output by the driving motor 9 is successively transmitted through the input shaft 2, the sun gear 51, the planet gears 53, the planet carrier 54, the input gear 41 and the output shaft 42 to the output shaft 3, and finally through a power transmission mechanism (for example, a differential) to the wheels of the electric vehicle. Transmission in the first gear state is particularly suitable for an electric vehicle driving at lower speed, such as at its start-up stage, or in a climbing or traffic jam condition.

As will be readily understood by skilled artisan, on the basis of a power transmission process similar to that of the two speed transmission shown in FIG. 2, the electric vehicle can be put into reverse gear merely by changing the rotating direction of the driving motor 9.

With reference to FIG. 3, it shows the power transmission process of the two speed transmission in second gear state. At this point, under the high pressure oil output by the oil pump 8, the driving disk 71 and the driven disk 72 of the clutch 7 are engaged and the driving disk 61 and driven disk 62 of the brake 6 are disengaged. Under such circumstance, the sun gear 51 is locked with the planet carrier 54; based on the rotation speed relationship of various components of the planetary mechanism 5; the rotation speeds of the sun gear 51, the planet carrier 54 and the outer ring gear 55 are the same now, that is, the whole planetary mechanism 5 has a transmission ratio of 1. The torque output by the driving motor 9 is transmitted through the planetary mechanism 5 without being decelerated, to the reducer 4 consisting of the input gear 41 and the output shaft 42, and further through the output shaft 3 and through a power transmission mechanism (for example, a differential) finally to the wheels of the electric vehicle. Transmission in the second gear state is particularly suitable for an electric vehicle driving at higher speed, such as in a road condition of less or almost no traffic jam.

Referring further to FIG. 2 and 3, when the electric vehicle is put into the second gear from the first gear, the driving and driven disks of the clutch 7 are gradually engaged with each other by the oil pump 8, and meanwhile the driving and driven disks of the brake 6 are gradually disengaged from one another. When the planet carrier 54 and the sun gear 51 have same rotation speed, the driving and driven disks of the clutch 7 are completely engaged and thus lock the planet carrier 54 and the sun gear 51 with each other, and at the same time, the driving and driven disks of the brake 6 are completely disengaged from each other, so far the vehicle is basically shifted from the first gear into the second gear. Similarly, when shifting from the second gear into the first gear, the driving and driven disks of the clutch 7 are gradually disengaged from each other by the oil pump 8, and meanwhile the driving and driven disks of the brake 6 are gradually engaged with one another. When the driving and driven disks of the brake 6 are completely engaged, they lock the outer ring gear 52 and the housing 1 with each other, and at the same time, the driving and driven disks of the clutch 7 are completely disengaged from each other, so far the vehicle is basically shifted from the second gear into the first gear.

As can be readily understood by those skilled in the art, during the process of shifting, because all components of the whole planetary mechanism 5 are in intermeshing state, the driving and driven disks of the clutch 7 and those of the brake 6 can be smoothly disengaged from or engaged with each other by reasonably adjusting the operation parameters of the oil pump 8 and the valve assembly with a control unit, thereby guaranteeing a continuous power supply during the shifting process of the vehicle and improving the vehicle's power performance. At the same time, shifting impact is effectively avoided, and the comfort of the electric vehicle is greatly improved.

The technical solutions of the application are described with reference to the preferred embodiments shown in the accompanying figures. As will be understood by those skilled in the art, however, these specific embodiments are not intended to limit protection scope of the application. Without departing from the principle of the application, various changes may be made and equivalents may be substituted for related technical features by those skilled in the art, the varied technical solutions are intended to fall within protection scope of the application.

What is claimed is:

1. A powertrain of two speed transmission for electric-only vehicle, comprising a housing as well as an input shaft and an output shaft provided in the housing and used for transmitting power, wherein the following components are provided within the housing:
a planetary mechanism which includes a sun gear, an outer ring gear and planet gears intermeshing respectively with the sun gear and the outer ring gear, the sun gear and the input shaft are in fixed connection with one another;
a reducer which includes an input gear into which the input shaft is inserted and an output gear intermeshing with the input gear, the input gear is connected with the planet gears, the output gear is fixed on the output shaft;
a clutch which has a clutch driving disk coaxially secured to the input shaft and a clutch driven disk coaxially secured to the input gear; and
a brake which has a brake driving disk in fixed connection with the housing and a brake driven disk in fixed connection with the outer ring gear.

2. The powertrain of two speed transmission for electric-only vehicle as set forth in claim 1, wherein the planetary mechanism further includes a planet carrier, one end of which is connected with the planet gears, another end of which is in fixed connection with the input gear.

3. The powertrain of two speed transmission for electric-only vehicle as set forth in claim 2, wherein the powertrain of two speed transmission further includes a power unit connected respectively with the clutch and the brake, enabling the clutch driving disk and the clutch driven disk to engage with or disengage from each other, and the brake driving disk and the brake driven disk to engage with or disengage from each other.

4. The powertrain of two speed transmission for electric-only vehicle as set forth in claim 3, wherein the power unit includes an oil pump, which is connected respectively with the clutch and the brake through lines.

5. The powertrain of two speed transmission for electric-only vehicle as set forth in claim 4, wherein the oil pump is connected respectively with the clutch driving disk and the brake driving disk through the lines.

6. The powertrain of two speed transmission for electric-only vehicle as set forth in claim 3, wherein the powertrain of two speed transmission further includes a control unit for controlling operation parameters of the power unit, the clutch driving and driven disks as well as the brake driving and driven disks are smoothly disengaged from or engaged with each other at preset rates by adjusting the operation parameters.

7. The powertrain of two speed transmission for electric-only vehicle as set forth in claim 1, wherein there is provided a supporting shaft in central axis direction of the outer ring gear which is connected to the housing by the supporting shaft in a rotatable way.

8. The powertrain of two speed transmission for electric-only vehicle as set forth in claim 1, wherein the planetary mechanism has a single row of planetary gears.

9. The powertrain of two speed transmission for electric-only vehicle as set forth in claim 1, wherein the clutch is a wet multi-disk clutch.

10. The powertrain of two speed transmission for electric-only vehicle as set forth in claim 1, wherein the power input end of the input shaft is connected with a driving motor.

11. The powertrain of two speed transmission for electric-only vehicle as set forth in claim 4, wherein the powertrain of two speed transmission further includes a control unit for controlling operation parameters of the power unit, the clutch driving and driven disks as well as the brake driving and driven disks are smoothly disengaged from or engaged with each other at preset rates by adjusting the operation parameters.

12. The powertrain of two speed transmission for electric-only vehicle as set forth in claim 2, wherein there is provided a supporting shaft in central axis direction of the outer ring gear which is connected to the housing by the supporting shaft in a rotatable way.

13. The powertrain of two speed transmission for electric-only vehicle as set forth in claim 2, wherein the planetary mechanism has a single row of planetary gears.

14. The powertrain of two speed transmission for electric-only vehicle as set forth in claim 2, wherein the clutch is a wet multi-disk clutch.

15. The powertrain of two speed transmission for electric-only vehicle as set forth in claim 2, wherein the power input end of the input shaft is connected with a driving motor.

16. The powertrain of two speed transmission for electric-only vehicle as set forth in claim 5, wherein the powertrain of two speed transmission further includes a control unit for controlling operation parameters of the power unit, the clutch driving and driven disks as well as the brake driving and driven disks are smoothly disengaged from or engaged with each other at preset rates by adjusting the operation parameters.

17. The powertrain of two speed transmission for electric-only vehicle as set forth in claim 3, wherein there is provided a supporting shaft in central axis direction of the outer ring gear which is connected to the housing by the supporting shaft in a rotatable way.

18. The powertrain of two speed transmission for electric-only vehicle as set forth in claim 3, wherein the planetary mechanism has a single row of planetary gears.

19. The powertrain of two speed transmission for electric-only vehicle as set forth in claim 3, wherein the clutch is a wet multi-disk clutch.

20. The powertrain of two speed transmission for electric-only vehicle as set forth in claim 3, wherein the power input end of the input shaft is connected with a driving motor.
